(19) United States
(12) Patent Application Publication
(10) Pub. No.: US 2016/0003381 A1
(43) Pub. Date: Jan. 7, 2016

(54) FLEXIBLE METAL PIPE, METHOD AND APPARATUS FOR PRODUCING THE SAME, AND HOSE COMPRISING THE FLEXIBLE METAL PIPE

(71) Applicant: CONTITECH RUBBER INDUSTRIAL KTF., Szeged (HU)

(72) Inventors: Jószeg Király, Tószeg (HU); Tibor Nagy, Budapest (HU); Tamás Katona, Algyo (HU); Gyula Bétéri, Érd (HU)

(21) Appl. No.: 14/772,491

(22) PCT Filed: Feb. 26, 2014
(86) PCT No.: PCT/HU2014/000019

§ 371 Date: Sep. 3, 2015

(30) Foreign Application Priority Data
Mar. 4, 2013 (HU) P1300129

(51) Int. Cl. F16L 11/16

(52) U.S. Cl. CPC F16L 11/16

(57) ABSTRACT

The invention relates to a flexible metal pipe spirally wound from profiled metal strips, wherein the width of the strip profiles is greater than the axial pitch measured at the direction of the principal axis of the flexible metal pipe, and the profiles may slide over one another as the flexible metal pipe is bent the essential feature of the invention being that the strip profile is made from at least two substantially or partially overlapping strips (1, 2, 3 . . . i). The invention also relates to manufacturing the above product, to apparatus for manufacturing the product, as well as to the application of the flexible metal pipe according to the invention.

The present invention relates to a flexible metal pipe made from metallic strip, method and apparatus for producing the same, and a hose comprising the flexible metal pipe. In the context of the present specification, the terms “hose” and “flexible conduit” are both used corresponding to the usage of the given technical field; however, for the purposes of the present invention the same thing is meant by these two terms.

As it is known in the art, flexible metal pipes bent from metal strip material are applied in various fields of industry. In addition to the term “flexible metal pipe”, in the English-language literature the terms “stripwound” and “flexible conduit” are also used to refer to this product, while in the standard ISO 13628-11 (2007) it is mentioned as “carcass”. Flexible metal pipes made from metal strip are widely applied as the innermost layer of hoses carrying gas-containing mediums (e.g. in the solution disclosed in patent specification U.S. Pat. No. 4,567,916), but frequently the external protection or armouring of hoses is also implemented applying flexible metal pipes. Such a solution is disclosed in patent specification U.S. Pat. No. 6,817,082. According to solutions presently applied in industrial practice for producing flexible metal pipes, a relatively narrow metallic strip is preformed utilizing profiled rollers, and then the preformed strip is spirally bent into a pipe wherein the profiles may slide over one another as the flexible metal pipe is being bent. In addition to stripwound flexible metal pipes, solutions for making flexible metallic pipes include for instance the so-called corrugated pipe, but these are not relevant for the purposes of the present invention, and therefore will not be discussed in the present specification.

Flexible metal pipes have been the object of several patent specifications, of which some will be mentioned below.

Certain types of flexible metal pipes have been known for over 100 years, for instance U.S. Pat. No. 1,009,964 discloses a flexible metal pipe made from preformed metal strip wound in an overlapping manner. In this old patent specification the flexible metal pipe was termed to be “interlocking”, but in present terminology we do not call it interlocking. Conforming to the current terminology, in the present patent specification those flexible metal pipes are termed to be interlocking wherein the edges of the individual strips are folded back such that they may become interlocked, and the back-folded portions of the individual turns overlap each other. The difference between interlocking and non-interlocking flexible metal pipes is discussed in more detail below referring to the accompanying drawings.

Patent specification U.S. Pat. No. 3,311,133 discloses a flexible metal pipe having an interlocking profile comprising a flexible sealing material.

The document with publication number US 2001/0015233 A1 discloses an interlocking-profile flexible metal pipe and a method for producing the same wherein the edges of the metal strip are rounded off.

Patent specification U.S. Pat. No. 1,962,428 discloses an interlocking-profile flexible metal pipe produced by winding two separately formed flexible metal pipes into each other.

Patent specification U.S. Pat. No. 7,121,591 B2 discloses multiple different interlocking-type flexible metal pipes, as well as the couplings thereof.

Patent specification HU 209 656 B and corresponding specifications EP 0 429 357 A1 and U.S. Pat. No. 6,016,847 disclose an improved version of the well-known interlocking profile for flexible metal pipes, where the interlocking sections contact one another at more than one points.

Patent specification U.S. Pat. No. 6,668,867 B1 discloses a flexible metal pipe wherein one edge of the strip of metal constituting the flexible is arranged to have a closed section in the profile.

As it has been mentioned above, for producing interlocking-profile flexible metal pipes the metallic strips are profiled utilizing rollers. The conventional method is applied only for producing relatively short flexible metal pipes (e.g. having a length of 10-20 m). According to this method, the profile is passed to a rotating conical mandrel, where the profile is “locked”, that is, the interlock is created, utilizing further rollers. In this case the completed flexible metal pipe undergoes rotating motion together with the mandrel, advancing relative to it in the direction of the axis thereof.

If very long flexible metal pipes are required (having a length of even several kilometres), then the manufacturing machine rotates around the flexible metal pipe being produced, while the flexible metal pipe undergoes only translational motion. Such methods and apparatus for carrying out the methods are, among others, disclosed in patents U.S. Pat. No. 4,597,276, U.S. Pat. No. 4,783,980, and U.S. Pat. No. 4,895,011. Apparatus based on this principle are far more complex and more expensive than those wherein the machine is stationary and the flexible metal pipe undergoes rotating and translational motion.

We do not know of any currently existing apparatus that would be capable of forming an interlocking flexible metal pipe profile directly on the surface of a rubber hose disposed on a mandrel.

Especially for of off-shore drilling and oil production such flexible metal pipes are required that are capable to withstand high external hydrostatic pressure difference. Such flexible metal pipes are applied as the innermost layer of hoses, or, to use the alternative term, flexible conduits. Hoses or flexible conduits comprising an internal flexible metal pipe are disclosed in a number of patent specifications, such as U.S. Pat. No. 4,567,916 mentioned above, or U.S. Pat. No. 6,145,546 and GB 2,167,521.

A distinction is made in the literature of the field between bonded (vulcanised rubber) and unbonded (plastic) flexible conduits that are presented in detail in the standard ISO 13628-11 (2007). The flexible metal pipe according to the present invention may be applied for both bonded and unbonded conduits.

According to current knowledge, in order to increase the resistance to external pressure the flexible metal pipe has to be made from a thicker strip material. However, the bending stiffness of the strip steeply increases with increasing thickness, and thereby more robust, bigger and more expensive apparatus is required for making the profile.

The object of the present invention is therefore to provide a flexible metallic pipe that may be produced easily, and yet it is capable of withstanding high external hydrostatic pressures. The flexible metal pipe according to the invention is partially based on the recognition that it is much easier to bend multiple strips of metal placed on top of one another than it is to bend a single, thicker metal strip, while at the same time the resistance to external pressure of the completed flexible metal pipe made from these multiple strips is not significantly reduced compared to a flexible metal pipe having the same total thickness but bent from a single strip. To differentiate it from flexible metal pipe profiles made from a single strip, in the following the flexible metal pipe according to the invention will be termed “multilayer flexible metal pipe”.

It is a known fact that the resistance to external pressure of a flexible metal pipe is substantially proportional to the second moment of inertia of the profile shape (provided that the pipe has constant profile width). We have found that, in case multiple metallic strips are bent on one another, the second moment of inertia of the resulting profile is reduced only by a minimal extent compared to profiles made from a single strip.

A further advantage of the multilayer flexible metal pipe according to the invention is that, in case of identical geometrical arrangement, the individual strips undergo smaller elongational and compressive deformation than in case of a pipe bent from a single strip. Thereby, the amount of residual stress is reduced, and other parameters, such as sulphide stress cracking (SCC) corrosion in hydrogen sulphide-containing media, and fatigue characteristics, will also become more favourable.

Another advantage is that, since the thinner strips may be bent to smaller radii without damage, the geometry of the flexible metal pipe may be modified in a broader range.

The invention therefore relates to a flexible metal pipe spirally wound from profiled metal strips, wherein the width of the strip profiles is greater than the axial pitch measured at the direction of the principal axis of the flexible metal pipe, and the profiles may slide over one another as the flexible metal pipe is bent, the essential feature of the solution being that the strip profile is made from at least two substantially or fully overlapping strips.

According to a preferred embodiment of the invention the strips of the flexible metal pipe comprise interlocking and overlapping lower and upper folds.

According to another preferred embodiment the flexible metal pipe has a non-interlocking profile.

In case of any two neighbouring and overlapping strips constituting the multilayer flexible metal pipe the center line of the spine of the profile is preferably shifted from the edge of the strip by 3-5 times the average thickness of the same two neighbouring strips.

In a preferred embodiment of the flexible metal pipe the bottom strip is not folded back, and it covers the lower crevice spirally extending along the interior of the flexible metal pipe; while in another embodiment the upper strip is not folded back, and it covers the upper crevice spirally extending along the exterior of the flexible metal pipe.

According to a conceivable embodiment of the invention the flexible metal pipe consists of at least three strips, and neither of the bottom or the upper strip is folded back, and both the lower and upper spirally extending crevices, in the interior and on the exterior of the flexible metal pipe, are covered.

In a preferred embodiment the upper fold of the strips of the flexible metal pipe is wave-shaped and is in contact with the neighbouring profile at a minimum of four locations; and it is also preferable if the angle between the principal direction of the folded-back strip(s) in the upper fold and the principal axis of the flexible metal pipe is 45-90° at least in a given area.

In specific cases the overlapping strips constituting the flexible metal pipe according to the invention are permanently secured to one another at a number of locations. The strips may for instance be secured to one another, by means of welding, either at the spine of the flexible metal pipe profile, or at the upper or lower flat, non-folded back section thereof. According to another embodiment, the strips are adhesively bonded together over their entire overlapping surface utilizing an adhesive that is in liquid state when the flexible metal pipe is formed, and provides a fixed bond after the manufacturing has been finished.

The scope of the invention also includes such hoses or flexible conduits that comprise the above described multilayer flexible metal pipe as their innermost layer or external armouring.

The invention further relates to a method for producing the flexible metal pipe, comprising the steps of profiling the strips constituting the flexible metal pipe in a manner known per se, and making a pipe from the strips by winding them on a conical mandrel. This may be carried out by joining together the strips constituting the flexible metal pipe according to the invention, and then shaping them together, or, preferably, forming at least the spine of the profile prior to forming a pipe from the strips, in a spatially or temporally separated manner for each strip, and joining the strips together only then.

Preferably, the centre of the respective spines of the individual strips is shifted relative to the edge of the strip by a value proportional to the average thickness of the two neighbouring strips, the value being 3-5 times the average thickness of said strips.

The invention also relates to an apparatus for carrying out the inventive method, wherein, in a manner known per se, the flexible metal pipe being manufactured and the manufacturing apparatus undergo both rotational and translational motion relative to each other, and the apparatus comprises a drum or reel adapted for unwinding the strips or pre-profiled strips as well as pairs of shaping rollers and profiled rollers, where the apparatus provides internal concentric support for the completed flexible metal pipe, the essential feature of the apparatus being that it has a die tool or a pair of rollers capable of joining together multiple strips. The apparatus is preferably capable of joining together several preprofiled strips, and comprises a die tool or a pair of pressure rollers that correspond in shape to the shape of the preprofiled strips.

A conceivable embodiment of the apparatus according to the invention is capable of making the multilayer flexible metal pipe directly over the surface of a hose. According to this embodiment the hose undergoes only rotation, while the apparatus advances in the axial direction of the machine at a rate corresponding to the pitch of the flexible metal pipe.

According to a preferred embodiment, the inventive apparatus comprises rollers mounted on hydraulic or pneumatic cylinders, the axis of the rollers can move radially towards the axis of the flexible metal pipe.

The flexible metal pipe according to the invention is explained in detail referring to the accompanying drawings.

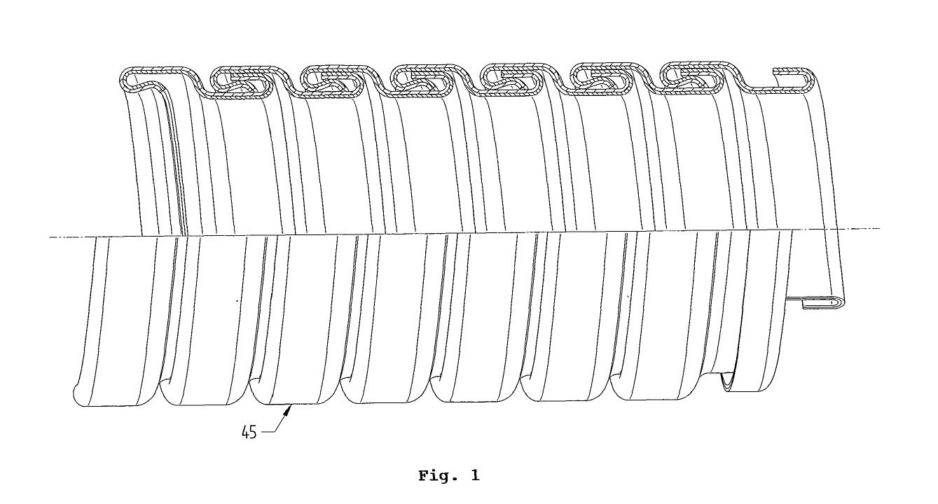

FIG. 1 shows a semi-sectional view of a preferred embodiment of the multilayer flexible metal pipe according to the invention.

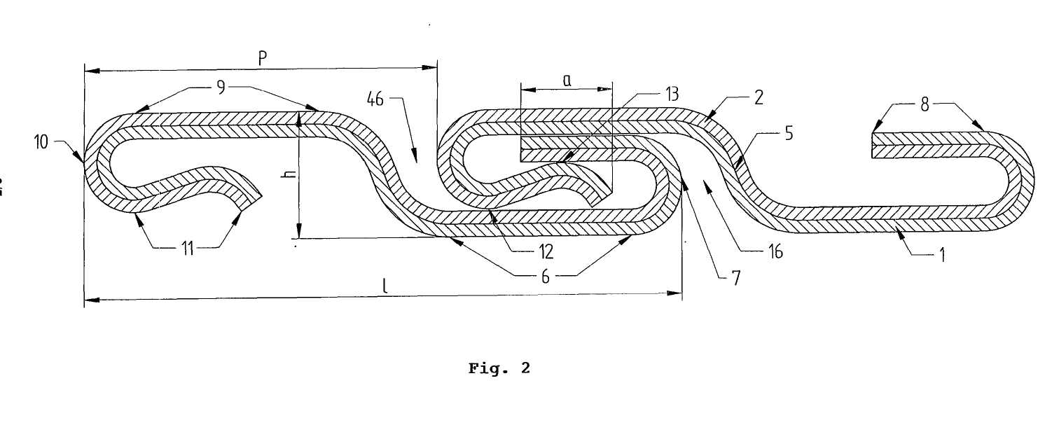

FIG. 2 shows a magnified view of the interlocking profile of a preferred embodiment of the multilayer flexible metal pipe according to the invention.

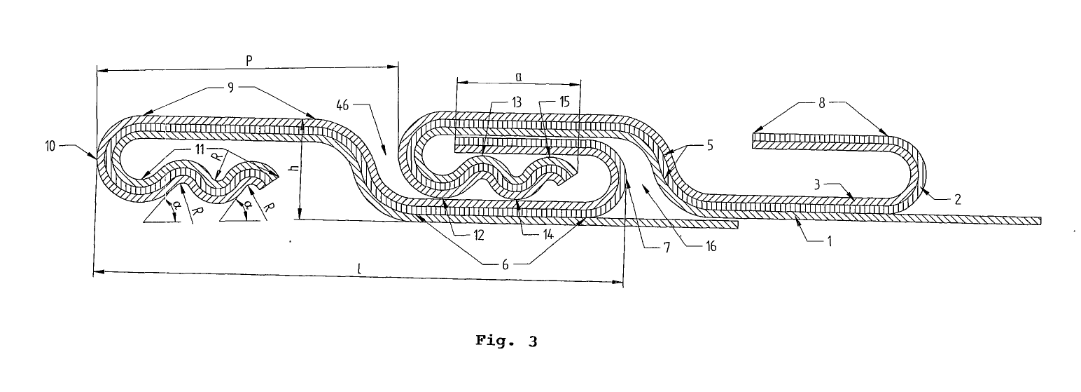

FIG. 3 shows a magnified view of the interlocking profile of a further conceivable embodiment of the multilayer flexible metal pipe according to the invention.

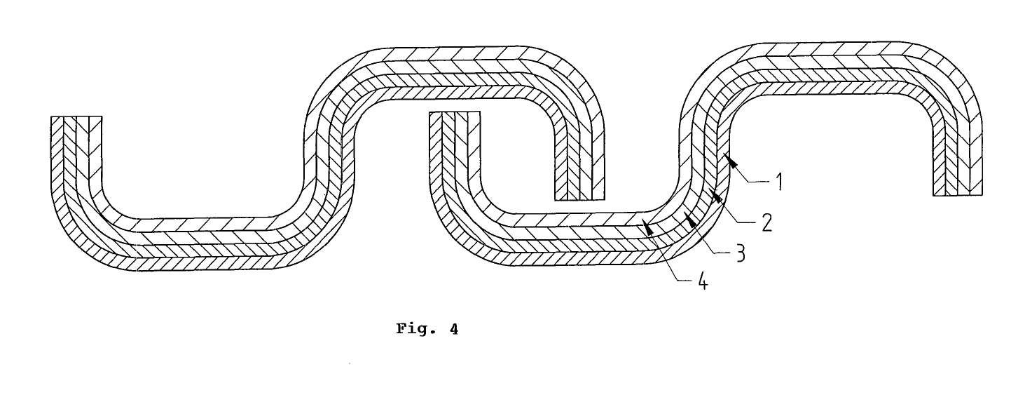

FIG. 4 shows a magnified view of a further preferred embodiment of the multilayer flexible metal pipe according to the invention, having non-interlocking profile.

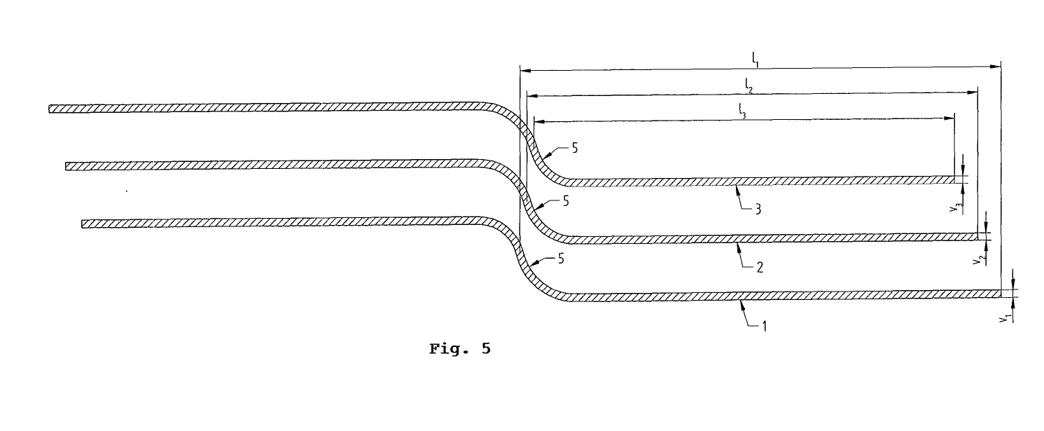

In FIG. 5 the preprofiled strip applied for manufacturing the multilayer flexible metal pipe according to the invention is shown in the initial phase of preprofiling.

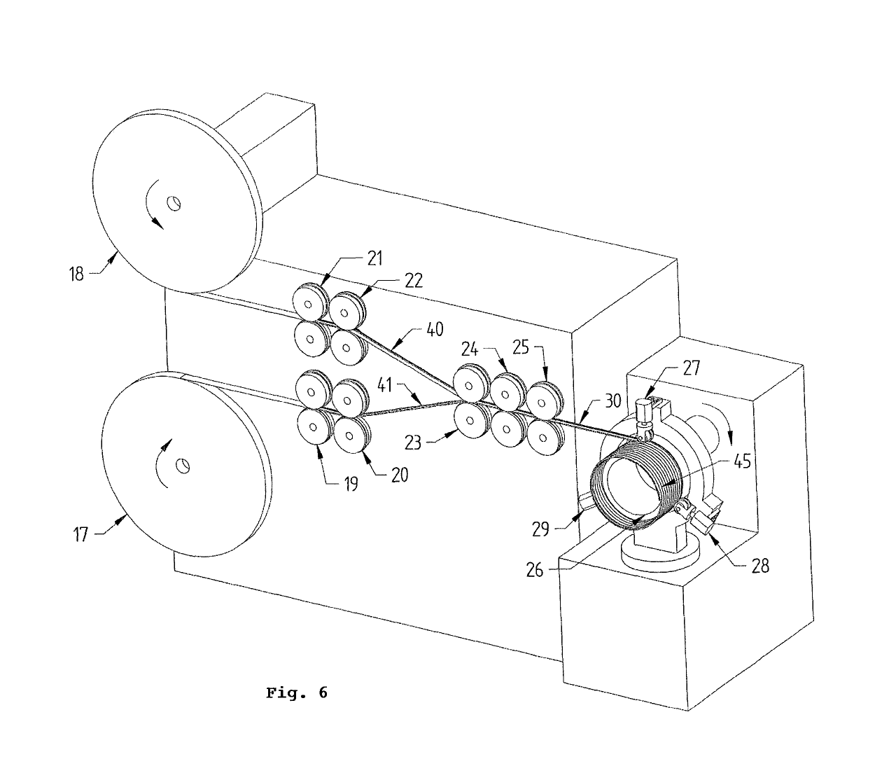

FIG. 6 illustrates a conceivable embodiment of the apparatus for manufacturing the multilayer flexible metal pipe according to the invention.

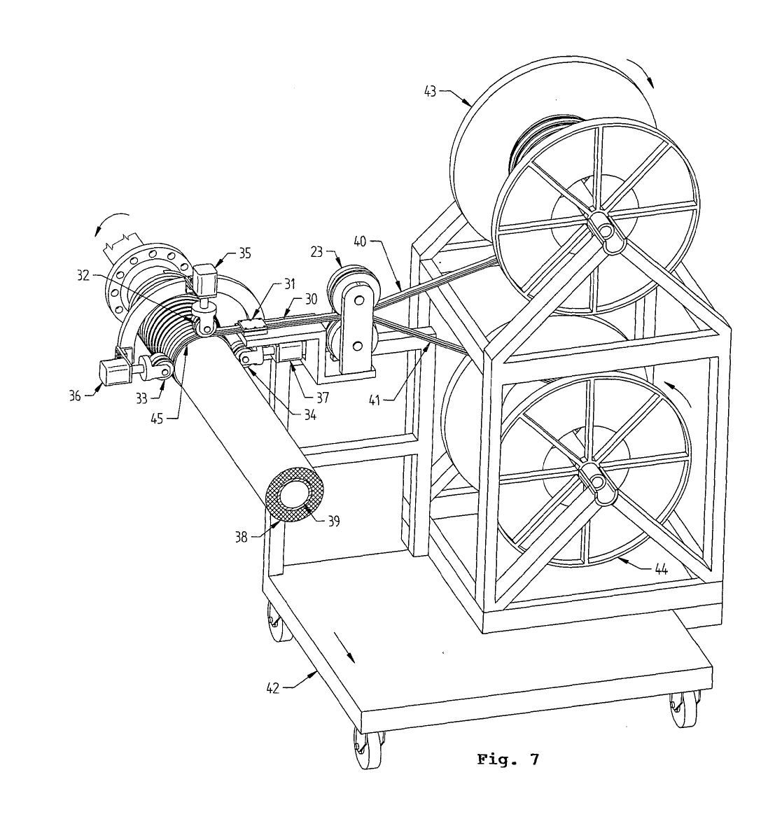

FIG. 7 illustrates a conceivable embodiment of an apparatus capable of forming external armouring to a rubber hose as multilayer flexible metal pipe according to the invention.

As it is apparent from the drawings, the multilayer flexible metal pipe according to the invention is made from spirally wound profiled metal strips 1, 2, . . . i, wherein the width I of the strip profiles is greater than the axial pitch P measured in the direction of the principal axis of the flexible metal pipe, and the profiles may slide over one another as the flexible metal pipe is bent, and the strip profile is made from at least two substantially or fully overlapping strips 1, 2, . . . i.

In a preferred embodiment of the multilayer flexible metal pipe according to the invention the profile is interlocking, and has a lower fold 7 and upper fold 10 that overlap each other at a length a.

In a further preferred embodiment the multilayer flexible metal pipe according to the invention comprises a non-interlocking profile termed S-profile.

In a preferred embodiment of the multilayer flexible metal pipe according to the invention the bottom strip 1 is not folded back, and it covers the lower crevice 16 spirally extending in the interior of the flexible metal pipe. Thereby, the inside surface of such a flexible metal pipe is substantially smooth.

In a further preferred embodiment of the flexible metal pipe according to the invention the upper strip is not folded back, and it covers the upper crevice 46 spirally extending on the exterior of the flexible metal pipe. Thereby, the outside surface of such a flexible metal pipe is substantially smooth.

In a further preferred embodiment of the flexible metal pipe according to the invention the pipe is made from at least three strips, and neither of the bottom strip 1 and the upper strip is folded back. The lower and upper crevices 16, 46 spirally extending, respectively, in the interior and on the exterior of the flexible metal pipe, are covered. Thereby, both the inside and the outside surfaces of such a flexible metal pipe are substantially smooth, and yet it retains its flexibility and withstands external hydrostatic pressure.

In another preferred embodiment of the flexible metal pipe according to the invention the curved section 11 of the upper fold 10 is wave-shaped and is in contact with the neighbouring profile at a minimum of four locations 12, 13, 14, 15. The angle between the curved section 11 of the folded-back strip(s) and the axis of the flexible metal pipe is preferably 45-90°, at least in a given area. In FIG. 3 this angle is denoted by α.

In specific cases the overlapping strips 1, 2, . . . i constituting the flexible metal pipe according to the invention are permanently bonded to one another locally. The strips may be bonded to one another at locations arranged along the spine 5 of the flexible metal pipe profile, or in either or both of the upper non-folded back, straight section 9 or the lower straight, non-folded back section 6, for instance by spot welding, resistance welding, soldering, or adhesive bonding. In case of applying an adhesive that is in a liquid state when the metal is shaped and sets only later, the overlapping strips 1, 2 . . . i may be secured together over their entire surface. Such adhesives are for instance cyanoacrylate-, epoxy resin-, or polyurethane-based adhesives that are all known to the person skilled in the art.

The solution according to the invention is explained in further detail referring to the accompanying drawings.

FIG. 1 illustrates a flexible metal pipe 45 according to the invention that comprises a conventional, interlocking profile consisting of two strips overlapping over their entire surface.

FIG. 2 shows a magnified cross-sectional view of the flexible metal pipe shown in FIG. 1. The flexible metal pipe is formed from a lower strip 1 and a second strip 2 that overlap substantially over their entire surface. The term “bottom strip” will be used below to refer to the strip that is disposed radially further inwards than the other with respect to the axis of the flexible metal pipe before the interlocking sections are made by back-folding the strips. It should be noted here that in the folded-back sections the bottom strip 1 is located radially further outwards from the axis of the hose. The finalised profile has a width I as measured parallel with the longitudinal axis of the flexible metal pipe, the total height of the profile being h measured in the radial direction, and the interlocking profile having an axial pitch P in the direction of the axis of the flexible metal pipe. A spine 5 is disposed approximately in the center line of the flexible metal pipe profile. The profile further comprises a straight bottom section 6 disposed nearly parallel with the axis of the flexible metal pipe, a lower fold 7 having a straight section 8 that is disposed nearly parallel with the axis of the flexible metal pipe, an upper straight section 9 that is disposed also parallel with the axis of the flexible metal pipe, and an upper fold 10 that has a curved back-folded section 11. The degree of interlock is determined by the overlap a between the straight section 8 of the lower fold 7 and the curved back-folded section 11 of the upper fold 10. In the flexible metal pipe shown in the drawing the lower fold 7 and the upper fold 10 are in contact at two points, at a bottom point of contact 12 and an upper point of contact 13. A lower crevice 16 extends spirally along the interior of the flexible metal pipe, the lower crevice 16 having a pitch P. The drawing also shows the upper crevice 46.

FIG. 3 presents a preferred embodiment of the flexible metal pipe according to the invention, wherein the profile is made up from three overlapping strips: a bottom strip 1, a second strip 2, and a third strip 3. The second strip 2 and the third strip 3 overlap each other substantially over their entire surface, and they also overlap the bottom strip 1 over the greater part of its surface. A spine 5 is disposed approximately in the center line of the flexible metal pipe profile. The profile further comprises a straight bottom section 6 disposed nearly parallel with the axis of the flexible metal pipe, and a lower fold 7 having a straight section 8 that is also disposed nearly parallel with the axis of the flexible metal pipe. The lower fold 7 is made up of only the second strip 2 and the third strip 3, the bottom strip 1 not being folded back over this section so that it covers the crevice 16 which is detrimental from the aspect of hydrodynamics. The flexible metal pipe shown in FIG. 3 further comprises an upper straight section 9 that is nearly parallel with the axis of the flexible metal pipe, an upper fold 10 having a curved back-folded section 11, and an upper crevice 46. In this embodiment the curved folded-back section 11 is wave-shaped, such that the lower fold 7 and the upper fold 10 are in contact at four points, at a bottom point of contact 12, an upper point of contact 13, a second bottom point of contact 14, and a second upper point of contact 15. The advantageous features of the multilayer flexible metal pipe according to the invention manifest themselves here as well: since the individual strips are thinner, in the curved folded-back section 11 the bend radius R of the strips at the inside arc may be significantly smaller than in case of conventional flexible metal pipes. In the curved folded-back section 11 the angle α between the steeply angled portion of the wave and the axis of the flexible metal pipe may be as high as 90°. FIG. 4 illustrates a conceivable embodiment of the multilayer flexible metal pipe according to the invention. This embodiment of the inventive flexible metal pipe has a non-interlocking, so-called S-profile, and constitutes of four strips overlapping one another over substantially their entire surface: a bottom strip 1, a second strip 2, a third strip 3, and a fourth strip 4.

The pitch P of the spiral-shaped metal strip profile of the multilayer flexible metal pipe according to the invention is smaller than the width I thereof, the flexible metal pipe constitutes of at least two strips overlapping each other over the greater part or the entirety of their surface: the bottom strip 1, the second strip 2, etc. The multilayer flexible metal pipe according to the invention may be made from more than two strips, that is, from three, four or more strips that overlap each other over the greater part or the entirety of their surface. The thicknesses of the strips may either be identical or different. The multilayer flexible metal pipe according to the present invention may have either interlocking or non-interlocking profiles. In a preferred embodiment of the multilayer flexible metal pipe according to the invention the profile is interlocking, and the curved section 11 of the upper fold 10 is arranged such that the lower fold 7 and the upper fold 10 contact each other at more than two points. In a preferred embodiment of the invention the curved folded-back section 11 is wave-shaped. In specific cases the curved folded-back section 11 may form more than one wave.

In a further preferred embodiment of the multilayer flexible metal pipe according to the invention the bottom strip 1 does not constitute a part of the lower fold 7, and only the second strip 2 (and the optionally included further strips 3, 4 . . . i) are folded back. The lower crevice 16, which increases the flow resistance of flexible metal pipes, is covered by the bottom strip 1, thereby significantly reducing flow resistance. It should be noted that it is expedient to choose the direction of flow such that the edge of the bottom strip 1 does not face the flow.

For implementing the method and apparatus for producing the multilayer flexible metal pipe according to the present invention relative motions should be considered. The flexible metal pipe being manufactured may undergo both rotational and translational motion, while the manufacturing machine either remains fixed, or may rotate around the flexible metal pipe that undergoes only translational motion. As making the multilayer flexible metal pipe according to the invention requires smaller forces than producing a flexible metal pipe from a single strip, it is sufficient to apply a less robust apparatus. The apparatus according to the invention may also be mounted on a trolley, and may be adapted to hose manufacturing machines wherein the hose undergoes only rotational motion while the profiling device advances in the direction of the axis of the hose. The smaller force requirement allows the operation to be carried out over the surface of such a hose that comprises an integrated coupling.

In the course of the method for manufacturing the multilayer flexible metal pipe according to the invention the strips making up the flexible metal pipe are either joined, and then shaped together, or in a preferred manner the spine 5 of each strip is initially made as the strip is passed between a respective pair of rollers. In FIG. 5 the preprofiled strip applied for manufacturing the flexible metal pipe, comprising three strips, according to the invention is shown in the initial phase of preprofiling, when only the spine 5 is profiled, and the strips are not yet joined together. The position of the spine 5 in the strip is chosen such that in the completed flexible metal pipe the edges of the strips are approximately aligned with one another. In case the bottom strip 1 has a thickness v₁, the second strip 2 has a thickness v₂, and that of the i-th strip is vᵢ, the centre of the spine 5 should be shifted between the bottom strip 1 and the second strip 2 by an amount x₁₂, and between the i-th and i+1-th strip, by an amount x_{i,i+1}, in proportion to the average thickness of the strips. The shift distance x_{1,2} is defined by equation (1):

x_{1,2}=I₁−I₂ (1)

where I₁ is the distance between the centre of the spine 5 of the bottom strip 1 and the edge of the same strip projected on the axis of the flexible metal pipe, and I₂ is the distance between the centre point of the spine 5 of the second strip and the edge thereof projected on the axis of the flexible metal pipe, before the strip is folded back. The value of the shift distance x_{1,2} is k times the average thickness of the bottom strip 1 and the second strip 2:

x_{1,2}=k(v₁+v₂)/2 (2)

Analogously, the shift between two neighbouring strips is obtained as:

x_{i,i+1}=k(vᵢ+vᵢ₊₁)/2 (3)

According to the present invention, k is between 3-5, that is, the shift distance is 3-5 times the average thickness of the two neighbouring strips. In other words, for any two neighbouring strips constituting the flexible metal pipe the center line of the spine 5 of the profile is shifted from the edge of the strip by 3-5 times the average thickness of the same two neighbouring strips.

In case the bottom strip 1 is not back-folded, such as for instance in case of the flexible metal pipe presented in FIG. 3, then of course the above shifting rule cannot be applied.

In the course of the method according to the present invention, the spines 5 of the strips of the flexible metal pipe are produced first, separately for each strip. That is, for each strip the spines 5 of the individual strips are formed in a temporally or spatially separated manner. This is to mean that the spines are either made simultaneously but in a spatially separated manner, utilizing separate pairs of rollers, or the strips are made as prefabricated items such that the spines 5 of the individual strips are formed at shifted positions corresponding to the position of the given strip in the assembled pipe. After the spines 5 have been made on each strip, the strips are joined together and, in a manner known to the person skilled in the art, the shape of the flexible metal pipe is finalised utilizing further forming rollers. In specific cases other shaped portions, such as the profile corresponding to the curved or wave-shaped folded-back section 11, or parts of the folded-back sections 7, 10, may also be formed prior to joining the strips together.

The individual strips 1, 2 . . . i are then joined together, and the flexible metal pipe comprising an interlocking or a non-interlocking profile is made in a manner known per se.

The apparatus according to the invention has a die tool or pair of rollers capable of joining together multiple strips. In a conceivable advantageous embodiment the apparatus comprises an unwinding device capable of simultaneously unwinding at least two strips, as well as at least two pairs of rollers capable of preforming the strips of the flexible metal pipe independently of one another. The apparatus further comprises a die tool or a pair of profiled rollers capable of joining the preformed strips together.

A preferred embodiment of the apparatus according to the invention is presented in more detail referring to FIG. 6. By way of example, an apparatus wherein the manufacturing machine is secured to the ground and the completed flexible metal pipe undergoes simultaneous rotating and translating motion is presented. As it has been mentioned above, for the purposes of the apparatus for manufacturing flexible metal pipes according to the present invention only relative motions are important. Thereby, in addition to the above presented solution, such an apparatus may also be conceived wherein the completed flexible metal pipe undergoes only translating motion relative to the ground, and the machine rotates around the flexible metal pipe. In another possible solution the completed flexible metal pipe undergoes only rotation, preferably on a rigid mandrel, or on a hose disposed on a rigid mandrel, while the manufacturing machine advances in the direction of the axis of the flexible metal pipe at a rate corresponding to the pitch of the pipe.

FIG. 6 illustrates an apparatus for producing two-layer flexible metal pipes. The apparatus comprises two unwinding devices, namely an unwinding device 17 adapted to unwind the bottom strip 1, and an unwinding device 18 adapted to unwind the second strip 2. For making the spine 5 of the bottom strip 1, pairs of driven profiled rollers 19, 20 are included, while the spine 5 of the second strip 2 is made utilizing pairs of driven profiled rollers 21, 22. The bottom strip 1 and the second strip 2 are also joined together applying a pair of rollers 23. Pairs of profiled rollers 24, 25 are adapted for further shaping the joined-together strips 1, 2. The preformed and joined-together strips 1, 2 are interlocked by a driven, rotating conical mandrel 26 and profiled rollers 27, 28, 29 disposed around it. The rollers 27, 28, 29 are adapted to be mechanically positioned both radially and axially (parallel with and perpendicular to the direction of the principal axis of the conical mandrel 26).

Internal concentric support for the completed flexible metal pipe 45 may be provided either by the driven, rotating conical mandrel 26, or a hose 38 itself as shown in FIG. 7 to be discussed below.

A further preferred embodiment of the apparatus according to the invention is capable of making a flexible metal pipe having an interlocking profile over the surface of a completed rubber hose 38 comprising a coupling. A problem is posed here by the fact that the external surface of the hose (the cover) is relatively soft and does not provide sufficient support for withstanding the high forces required for shaping conventional single-layer flexible metal pipes. By applying the multilayer flexible metal pipe according to the invention, this problem is solved, because the inventive flexible metal pipe may be shaped applying lower forces. Furthermore, such hoses have a conical surface section next to their coupling, involving that the diameter of the flexible metal pipe should also change over this section, which also poses a problem, since the mechanically positioned rollers 27, 28, 29 are not capable of following such a change in diameter. In this embodiment of the apparatus according to the invention the lower fold 7 and the upper fold 10 are formed by rollers that are either driven by the strip itself that constitutes flexible metal pipe, or have electric or hydraulic torque assist drive means.

The rollers can be moved radially with respect to the axis of the hose by hydraulic or pneumatic cylinders 35, 36, 37, and the force between the rollers and the flexible metal pipe may be adjusted by adjusting the pressure of the cylinders such that the multilayer strip profile constituting the flexible metal pipe is bent to an interlocking shape. In a preferred implementation of this embodiment the hose undergoes only rotating motion, while the pipe manufacturing apparatus moves parallel with the axis of the hose. A conceivable embodiment of the apparatus is shown in FIG. 7 By way of example, the apparatus presented herein utilizes a two-layer flexible metal pipe 45, but a pipe comprising more than two layers may obviously also be applied. The production of the preprofiled strips 40, 41 is temporally separated from applying the strips to the hose. The hose 38 to which the external flexible metal pipe is to be applied is secured to a mandrel 39. The unit adapted for applying the flexible metal pipe to the hose is mounted on a trolley 42 that advances parallel with the common axis of the hose 38 and the mandrel 39 such that for each turn of the mandrel 39 the trolley 42 moves by an amount corresponding to the pitch P of the completed flexible metal pipe 45. The preprofiled strips 40, 41 are joined together applying a pair of rollers 23 to form a joined-together preprofiled strip 30. The joined-together preprofiled strip 30 is passed to the surface of the hose and to the rollers 32, 33, 34 adapted for interlocking the profile, through a die tool 31 having a corresponding shape. The rollers 32, 33, 34 are pressed against the joined-together preprofiled strip 30 by pneumatic or hydraulic cylinders 35, 36, 37. The rollers 32, 33, 34 are adapted to be mechanically positioned in a direction parallel with the principal axis of the hose.

Thereby, the method for producing multilayer flexible metal pipes comprises the steps of profiling the strips 1, 2, . . . i constituting the flexible metal pipe in a manner known per se, and making a pipe from the strips by winding them on a conical mandrel. At least the spine 5 of the profile is formed prior to forming a pipe from the strips, in a spatially or temporally separated manner for each strip, the strips then being joined together.

In a preferred embodiment of the method according to the invention the centre of the respective spines 5 of the individual strips is shifted relative to the edge of the strip by a value proportional to the average thickness of the two neighbouring strips, the value being 3-5 times the average thickness of said strips.

In a manner known per se, the flexible metal pipe being manufactured and the manufacturing apparatus according to the invention undergo both rotational and translational motion relative to each other. The apparatus comprises a die tool 31 and/or a pair of pressure rollers 23 corresponding in shape to the shape of the preprofiled strips, and capable of joining together multiple preprofiled strips 1, 2 . . . i. In a further preferred embodiment of the apparatus the hose or mandrel undergoes only rotary motion, while the apparatus advances in the axial direction of the machine at a rate corresponding to the pitch of the flexible metal pipe, and the apparatus comprises force-controlled rollers 32, 33, 34 adapted for interlocking the joined strips 1, 2, . . . i, where the rollers are mounted on hydraulic or pneumatic cylinders 35, 36, 37 such that the rollers can be moved radially towards the axis the flexible metal pipe.

The scope of the invention also includes hoses and flexible conduits equipped with the multilayer flexible metal pipe according to the invention, irrespective of whether the inventive multilayer flexible metal pipe is applied as an internal stripwound pipe (carcass) or external armouring for bonded (rubber) or unbonded (plastic) hoses.

1. A flexible metal pipe spirally wound from profiled metal strips, wherein the width of the strip profiles is greater than the axial pitch measured at the direction of the axis of the flexible metal pipe, and the profiles may slide over one another as the flexible metal pipe is bent, made from at least two substantially or fully overlapping strips wherein, for any two neighbouring strips the center line of the spine of the profile is shifted from the edge of the strip by 3-5 times the average thickness of said two neighbouring strips.

2. The flexible metal pipe according to claim 1, wherein the bottom strip is not folded back, and it covers the lower crevice spirally extending in the interior of the flexible metal pipe.

3. The flexible metal pipe according to claim 1, wherein the upper strip is not folded back, and it covers the upper crevice spirally extending on the exterior of the flexible metal pipe.

4. The flexible metal pipe according to claim 1, further comprising at least three strips, and neither the bottom strip nor the upper, third strip is folded back, and both the lower and upper spirally extending crevices, respectively, in the interior and on the exterior of the flexible metal pipe, are covered.

5. The flexible metal pipe according to claim 1, wherein the upper fold is wave-shaped and is in contact with the neighbouring profile at a minimum of four locations.

6. The flexible metal pipe according to claim 5, wherein the angle between the folded-back strip(s) in the upper fold and the axis of the flexible metal pipe is 45-90° at least in a given area.

7. The flexible metal pipe according to claim 1, wherein the overlapping strips comprising the flexible metal pipe are permanently bonded to one another.

8. The flexible metal pipe according to claim 7, wherein the strips are bonded to one another, by welding, soldering or adhesive joints, either at the spine of the flexible metal pipe profile, or at the upper or lower flat, non-folded back section thereof.

9. A hose or flexible conduit, wherein the innermost layer or the external armouring thereof comprising the multilayer flexible metal pipe according to claim 1.

10. A method for manufacturing the flexible metal pipe according to claim 1, comprising the steps of profiling the strips comprising the flexible metal pipe, and making a pipe from the strips by winding them on a conical mandrel, wherein at least the spine of the profile is formed prior to forming a pipe from the strips, in a spatially or temporally separated manner for each strip, for any two neighbouring strips the center line of the spine of the profile is shifted from the edge of the strip by 3-5 times the average thickness of said two neighbouring strips, the strips then being joined together.

11. An apparatus for manufacturing the flexible metal pipe according to claim 1, wherein the flexible metal pipe being manufactured and the manufacturing apparatus undergo rotational and translational motion relative to each other, the apparatus comprising a drum or reel adapted for unwinding the strips or preprofiled strips, and pairs of shaping rollers and profiled rollers, where the apparatus provides internal concentric support for the completed flexible metal pipe, wherein the apparatus comprises a die tool or a pair or pairs of pressure rollers adapted to join together more than one strips with shifted spine.

12. The apparatus according to claim 11, wherein the hose or mandrel undergoes only rotary motion, while the apparatus advances in the axial direction of the machine at a rate that corresponds to the pitch of the flexible metal pipe.

13. The apparatus according to claim 12, wherein the apparatus further comprises force-controlled rollers adapted for interlocking the joined strips, where the rollers are mounted on hydraulic or pneumatic cylinders such that the rollers can be moved radially towards the axis of the flexible metal pipe.
